(19) United States
(12) Patent Application Publication
(10) Pub. No.: US 2025/0142563 A1
(43) Pub. Date: May 1, 2025

(54) METHOD AND APPARATUS FOR SYNCHRONOUS RECONFIGURATION IN MOBILE WIRELESS COMMUNICATION SYSTEM

(71) Applicants: Soenghun KIM, Hanam-si (KR); BLACKPIN INC., Seoul (KR)

(72) Inventor: Soenghun KIM, Hanam-si (KR)

(21) Appl. No.: 18/923,142

(22) Filed: Oct. 22, 2024

(30) Foreign Application Priority Data
Oct. 31, 2023 (KR) 10-2023-0147424

(51) Int. Cl. H04W 72/1268; H04W 28/02; H04W 36/24

(52) U.S. Cl. CPC H04W 72/1268; H04W 28/0278; H04W 36/249

(57) ABSTRACT

The present invention provides a method and system for implementing handover in NR networks, addressing the challenges associated with mobility management and ensuring efficient and reliable communication. The proposed solution leverages advanced algorithms and protocols to enhance the handover procedure, minimizing latency and reducing the likelihood of connection drops. By employing both network-controlled and UE-controlled handover mechanisms, the invention ensures robust and adaptive mobility management, catering to various network scenarios and user requirements. The proposed solution enables the terminal and the base station to perform appropriate type of synchronous reconfiguration in a given situation.

### CROSS-REFERENCE TO RELATED APPLICATION

This application claims priority to and the benefit of Korean Patent Application No. 10-2023-0147424, filed on Oct. 31, 2023, the disclosure of which is incorporated herein by reference in its entirety.

### TECHNICAL FIELD

The present disclosure relates to performing synchronous reconfiguration in wireless mobile communication system.

### BACKGROUND

In the evolving landscape of New Radio (NR) technology, seamless connectivity and uninterrupted communication are paramount for ensuring a high-quality user experience. Handover based on synchronous reconfiguration is a critical process that facilitates the transfer of an ongoing communication session from one cell to another as the user equipment (UE) moves through different coverage areas. This process is essential for maintaining the continuity of the user's connection and optimizing network performance.

Synchronous reconfiguration process is heavily depending on random access procedure, which poses burdens both to processing and to network resources.

This invention aims to improve the overall performance of NR networks by providing a comprehensive handover solution that enhances user experience, optimizes resource utilization, and supports the dynamic nature of modern cellular communication systems.

### SUMMARY

Aspects of the present disclosure are to address the problems of synchronous reconfiguration in mobile network. More specifically, the present disclosure provides method and apparatus to perform uplink transmission in the target cell after synchronous reconfiguration. The method of the terminal includes triggering a buffer status report (BSR) in case that uplink data for a specific logical channel becomes available, triggering a scheduling request (SR) in case that no uplink resource is available for new transmission, and cancelling the SR without transmission of the SR in case that no valid PUCCH resource configured for the SR is available and a specific radio resource control (RRC) message does not comprise a specific set of parameters. The specific set of parameters comprises at least a parameter related to timing adjustment for a specific set of serving cells.

### BRIEF DESCRIPTION OF THE DRAWINGS

FIG. 1A is a diagram illustrating the architecture of an 5G system and a NG-RAN to which the disclosure may be applied.

FIG. 1B is a diagram illustrating a wireless protocol architecture in an 5G system to which the disclosure may be applied.

FIG. 1C is a diagram illustrating architecture of NTN

FIG. 1D is a diagram illustrating protocol architecture of NTN.

FIG. 2A illustrates overall operation of the UE and network.

FIG. 2B illustrates the operation of the UE regarding PLMN selection and cell selection and cell reselection.

FIG. 2C illustrates RRC connection establishment procedure.

FIG. 2D illustrates UE capability transfer procedure.

FIG. 2E illustrates RRC connection reconfiguration procedure.

FIG. 2F illustrates data transfer procedure in RRC_CONNECTED state.

FIG. 2G illustrates random access procedure.

FIG. 2H illustrates scheduling request procedure based on dedicate scheduling request resource.

FIG. 2I illustrates buffer status reporting procedure.

FIG. 3A is a diagram illustrating operations of a terminal and a base station according to an embodiment of the present invention.

FIG. 4A is a flow diagram illustrating an operation of a terminal.

FIG. 5A is a block diagram illustrating the internal structure of a UE to which the disclosure is applied.

FIG. 5B is a block diagram illustrating the configuration of a base station according to the disclosure.

### DETAILED DESCRIPTION

Hereinafter, embodiments of the present invention will be described in detail with reference to the accompanying drawings. In addition, in the description of the present invention, if it is determined that a detailed description of a related known function or configuration may unnecessarily obscure the gist of the present invention, the detailed description thereof will be omitted. In addition, the terms to be described later are terms defined in consideration of functions in the present invention, which may vary according to intentions or customs of users and operators. Therefore, the definition should be made based on the content throughout this specification.

The terms used, in the following description, for indicating access nodes, network entities, messages, interfaces between network entities, and diverse identity information is provided for convenience of explanation. Accordingly, the terms used in the following description are not limited to specific meanings but may be replaced by other terms equivalent in technical meanings.

In the following descriptions, the terms and definitions given in the 3GPP standards are used for convenience of explanation. However, the present disclosure is not limited by use of these terms and definitions and other arbitrary terms and definitions may be employed instead.

In the present invention, “trigger” or “triggered” and “initiate” or “initiated” can be used interchangeably.

In the present invention, UE and terminal can be used interchangeably. In the present invention, NG-RAN node and base station and GNB can be used interchangeably.

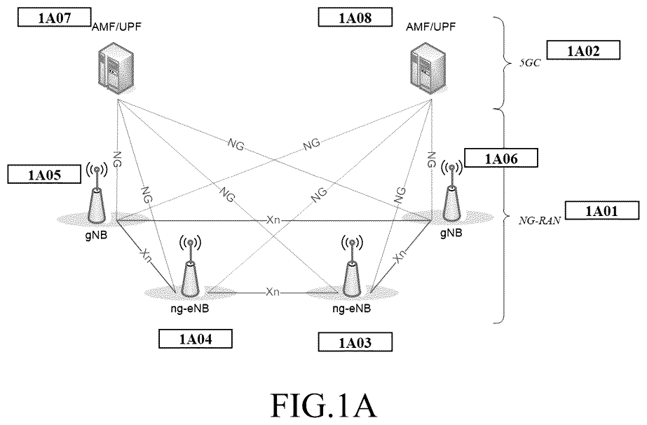

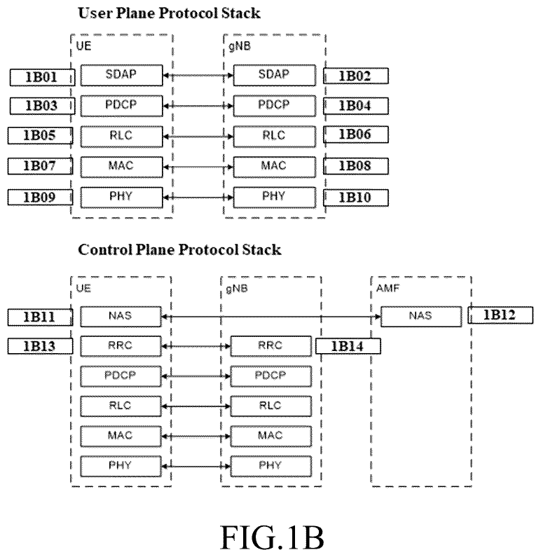

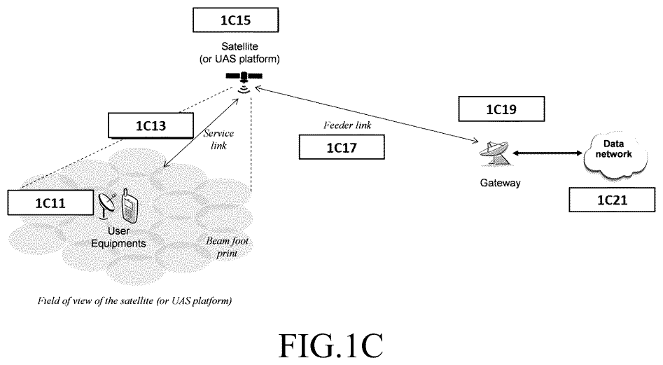

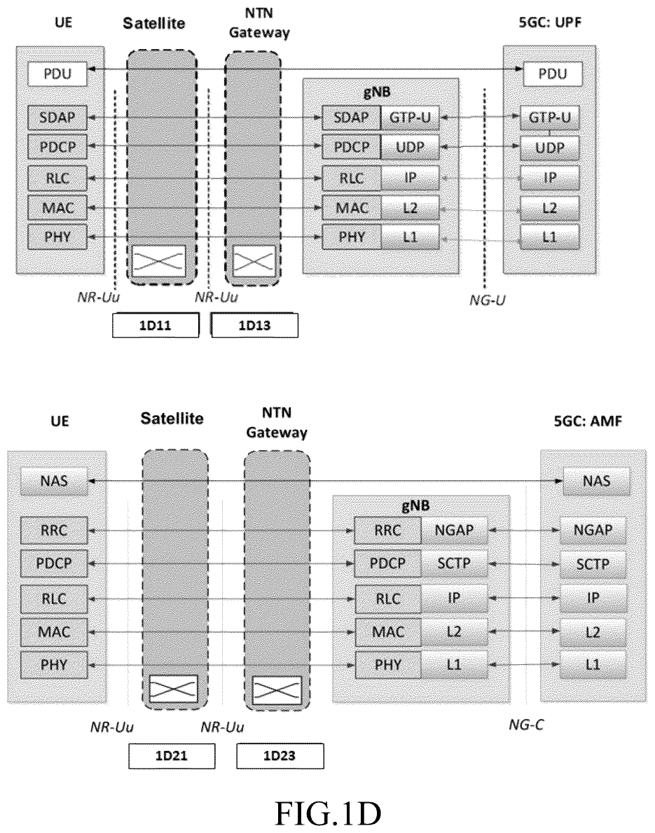

FIG. 1A is a diagram illustrating the architecture of an 5G system and a NG-RAN to which the disclosure may be applied.

5G system consists of NG-RAN 1A01 and 5GC 1A02. An NG-RAN node is either:
a gNB, providing NR user plane and control plane protocol terminations towards the UE; or
an ng-eNB, providing E-UTRA user plane and control plane protocol terminations towards the UE.

The gNBs 1A05 or 1A06 and ng-eNBs 1A03 or 1A04 are interconnected with each other by means of the Xn interface. The gNBs and ng-eNBs are also connected by means of the NG interfaces to the 5GC, more specifically to the AMF (Access and Mobility Management Function) and to the UPF (User Plane Function). AMF 1A07 and UPF 1A08 may be realized as a physical node or as separate physical nodes.

A gNB 1A05 or 1A06 or an ng-eNBs 1A03 or 1A04 hosts the functions listed below.

Functions for Radio Resource Management such as Radio Bearer Control, Radio Admission Control, Connection Mobility Control, Dynamic allocation of resources to UEs in uplink, downlink and sidelink (scheduling); and
IP and Ethernet header compression, uplink data decompression and encryption of user data stream; and
Selection of an AMF at UE attachment when no routing to an MME can be determined from the information provided by the UE; and
Routing of User Plane data towards UPF; and
Scheduling and transmission of paging messages; and
Scheduling and transmission of broadcast information (originated from the AMF or O&M); and
Measurement and measurement reporting configuration for mobility and scheduling; and
Session Management; and
QoS Flow management and mapping to data radio bearers; and
Support of UEs in RRC_INACTIVE state; and
Radio access network sharing; and
Tight interworking between NR and E-UTRA; and
Support of Network Slicing.

The AMF 1A07 hosts the functions such as NAS signaling, NAS signaling security, AS security control, SMF selection, Authentication, Mobility management and positioning management.

The UPF 1A08 hosts the functions such as packet routing and forwarding, transport level packet marking in the uplink, QoS handling and the downlink, mobility anchoring for mobility etc.

FIG. 1B is a diagram illustrating a wireless protocol architecture in an 5G system to which the disclosure may be applied.

User plane protocol stack consists of SDAP 1B01 or 1B02, PDCP 1B03 or 1B04, RLC 1B05 or 1B06, MAC 1B07 or 1B08 and PHY 1B09 or 1B10. Control plane protocol stack consists of NAS 1B11 or 1B12, RRC 1B13 or 1B14, PDCP, RLC, MAC and PHY.

Each protocol sublayer performs functions related to the operations listed below.

NAS: authentication, mobility management, security control etc.

RRC: System Information, Paging, Establishment, maintenance and release of an RRC connection, Security functions, Establishment, configuration, maintenance and release of Signalling Radio Bearers (SRBs) and Data Radio Bearers (DRBs), Mobility, QoS management, Detection of and recovery from radio link failure, NAS message transfer etc.

SDAP: Mapping between a QoS flow and a data radio bearer, Marking QoS flow ID (QFI) in both DL and UL packets.

PDCP: Transfer of data, Header compression and decompression, Ciphering and deciphering, Integrity protection and integrity verification, Duplication, Reordering and in-order delivery, Out-of-order delivery etc.

RLC: Transfer of upper layer PDUs, Error Correction through ARQ, Segmentation and re-segmentation of RLC SDUs, Reassembly of SDU, RLC re-establishment etc.

MAC: Mapping between logical channels and transport channels, Multiplexing/demultiplexing of MAC SDUs belonging to one or different logical channels into/from transport blocks (TB) delivered to/from the physical layer on transport channels, Scheduling information reporting, Priority handling between UEs, Priority handling between logical channels of one UE etc.

PHY: Channel coding, Physical-layer hybrid-ARQ processing, Rate matching, Scrambling, Modulation, Layer mapping, Downlink Control Information, Uplink Control Information etc.

The terminal supports three RRC states.

RRC_IDLE state can be characterized with followings:
PLMN selection; Broadcast of system information;
Cell re-selection mobility;
Paging for mobile terminated data is initiated by 5GC;
DRX for CN paging configured by NAS.
RRC_INACTIVE state can be characterized with followings:
PLMN selection; Broadcast of system information;
Cell re-selection mobility;
Paging is initiated by NG-RAN (RAN paging);
RAN-based notification area (RNA) is managed by NG-RAN;
DRX for RAN paging configured by NG-RAN;
5GC-NG-RAN connection (both C/U-planes) is established for UE;
The UE AS context is stored in NG-RAN and the UE;
NG-RAN knows the RNA which the UE belongs to.
RRC_CONNECTED state can be characterized with followings:
5GC-NG-RAN connection (both C/U-planes) is established for UE;
The UE AS context is stored in NG-RAN and the UE;
NG-RAN knows the cell which the UE belongs to;
Transfer of unicast data to/from the UE;
Network controlled mobility including measurements.

FIG. 1C is a diagram illustrating architecture of NTN.

A non-terrestrial network refers to a network, or segment of networks using RF resources on board a satellite (or UAS platform).

The typical scenario of a non-terrestrial network providing access to user equipment is depicted in FIG. 1D.

Non-Terrestrial Network typically consists of the following elements:

One or several sat-gateways 1C19 that connect the Non-Terrestrial Network to a public data network 1C21. A Feeder link 1C17 or radio link between a sat-gateway and the satellite. A service link 1C13 or radio link between the user equipment and the satellite. A satellite 1C15 providing RF resource. User Equipment 1C11 served by the satellite within the targeted service area.

FIG. 1D is a diagram illustrating protocol architecture of NTN.

Satellite 1D11 or 1D21 and NTN gateway 1D13 and 1D 23 are equipped with RF processing & Frequency Switching to relay the signal between gNB and UE. Other protocols such as SDAP, PDCP, RLC, MAC, PHY, RRC, NAS are same as used in normal terrestrial network.

RRC reconfiguration is a procedure to change various configuration of a UE. RRC reconfiguration could be performed either in asynchronous manner or in synchronous manner.

In asynchronous reconfiguration, the new configuration information is provided by a RRC message (e.g. RRCSetup, RRCReconfiguration wihtout Reconfiguration WithSync). UE applies the new configuration when the contents of the RRC message is successfully decoded. The base station applies the new configuration when the RRC message is considered successfully transmitted. Since UE and base station apply the new configuration at different point of time, it is considered as asynchronous reconfiguration.

In synchronous reconfiguration, random access procedure between UE and the base station is performed before the new configuration is applied. Upon successful completion of random access procedure, UE and base station applies the new configuration almost simultaneously.

Synchronous reconfiguration is applied for various procedure including handover. Since handover involve PCI change and layer 2 reset and security key change, the reconfiguration needs to be synchronized between the UE and the base station.

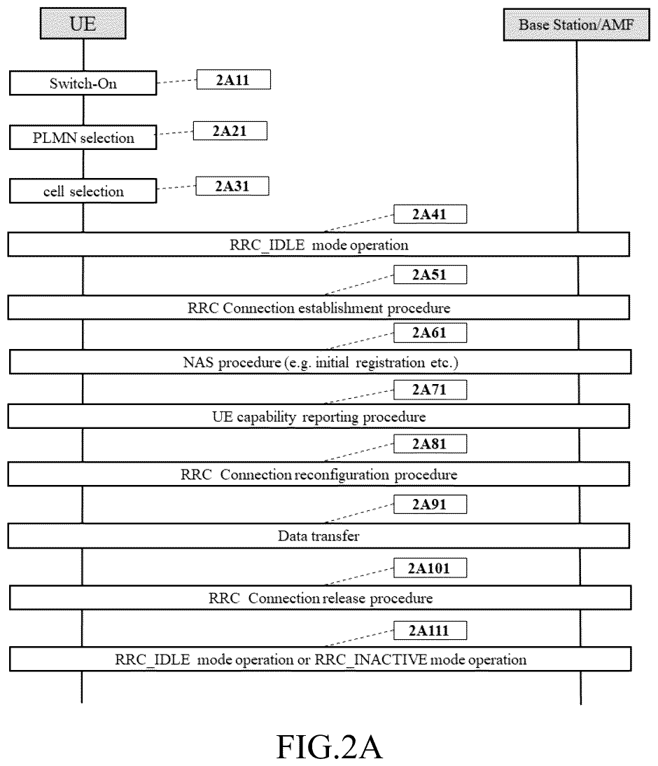

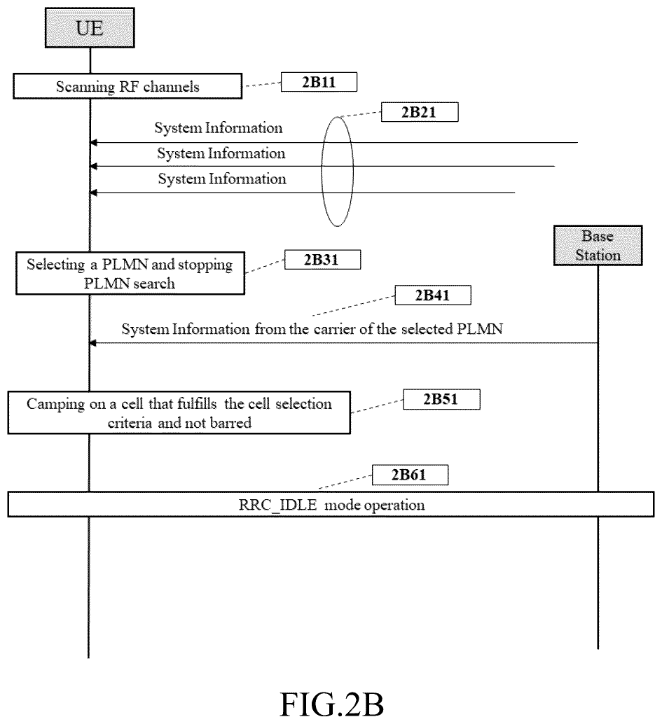

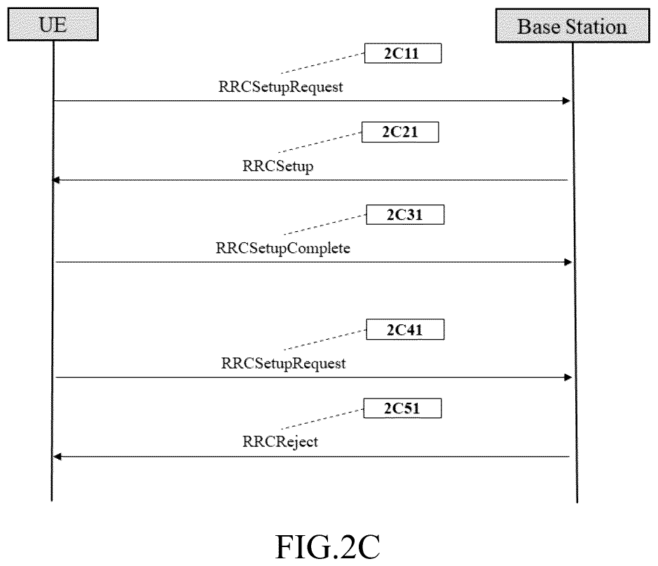

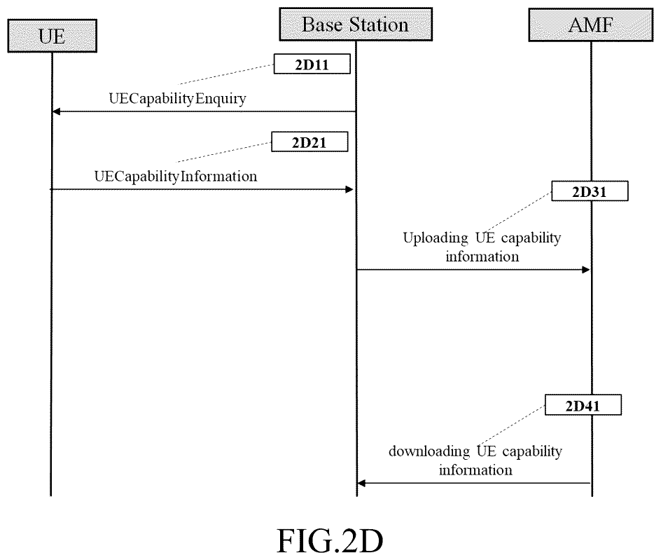

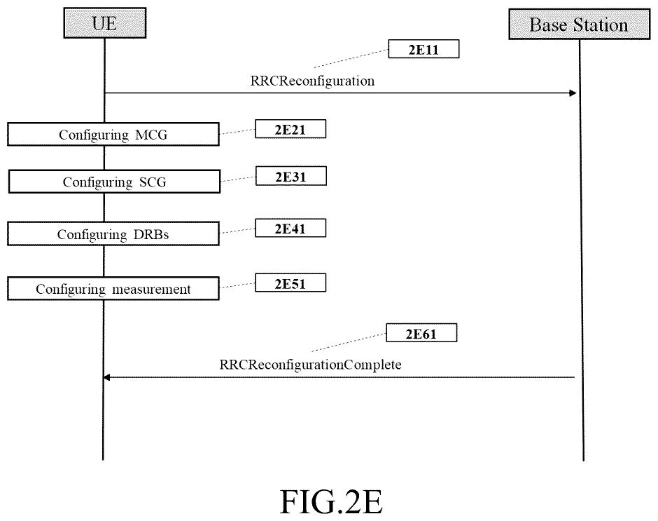

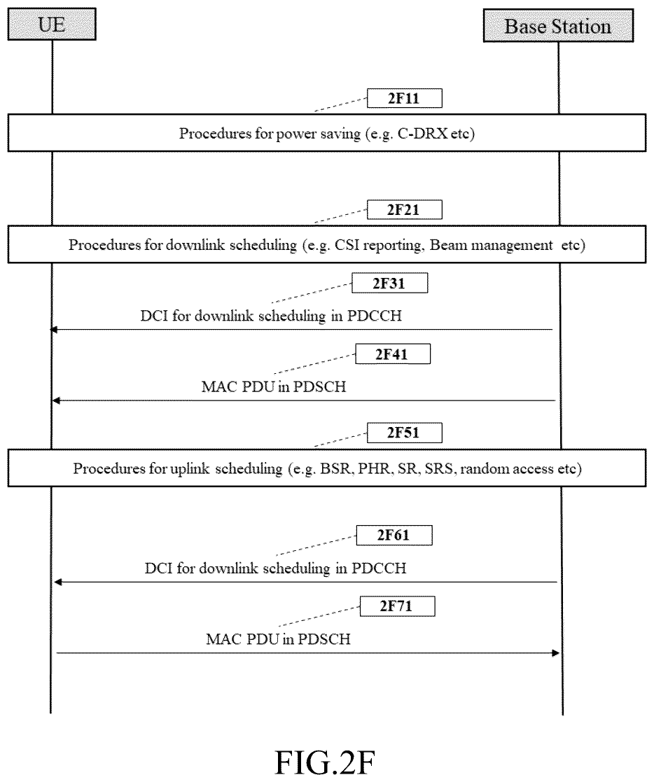

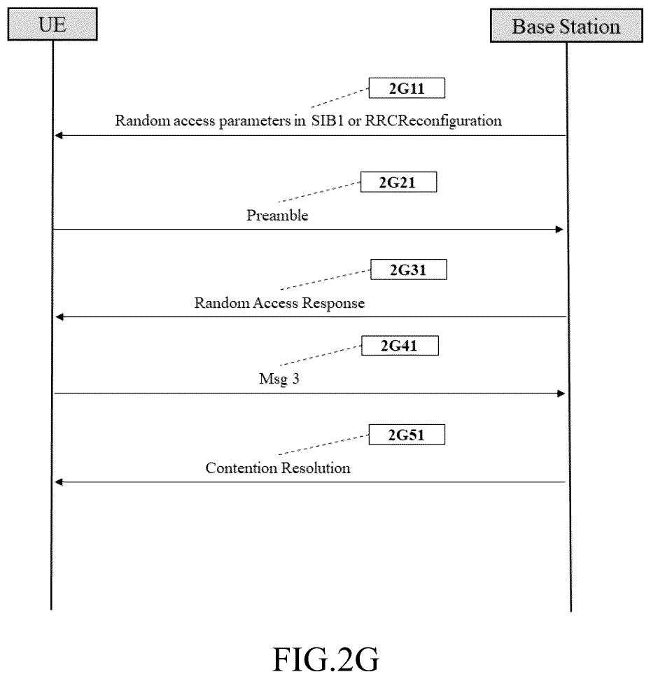

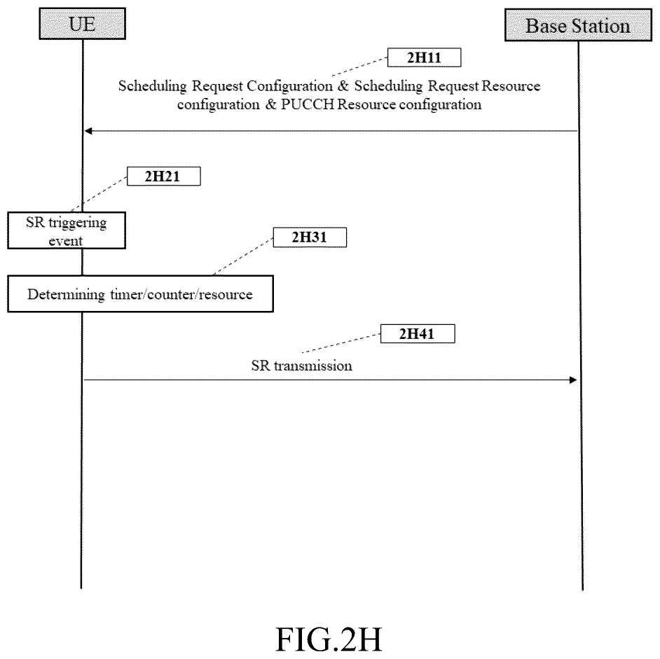

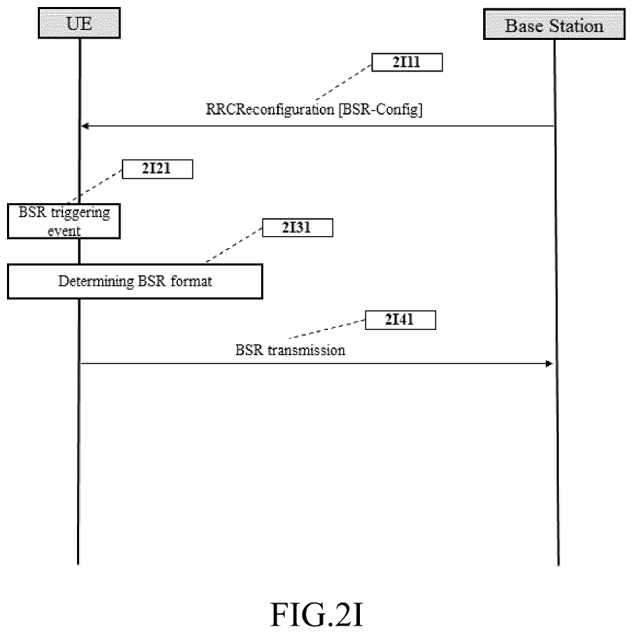

FIG. 2A illustrates overall operation of the UE and network.

Upon switch-on of the wireless device (e.g. UE) 2A11, UE performs PLMN selection 2A21 to select the carrier that is provided by the PLMN that UE is allowed to register.

Then UE performs cell selection 2A31 to camp on a suitable cell.

Once camping on a suitable cell, UE performs RRC_IDLE mode operation 2A41 such as paging channel monitoring and cell reselection and system information acquisition.

UE performs RRC Connection establishment procedure 2A51 to perform e.g. NAS procedure such as initial registration with the selected PLMN.

After successful RRC connection establishment, UE performs NAS procedure 2A61 by transmitting a corresponding NAS message via the established RRC connection (e.g. SRB1).

The base station can trigger UE capability reporting procedure 2A71 before configuring data bearers and various MAC functions.

The base station and the UE perform RRC connection reconfiguration procedure 2A81. Via the procedure, data radio bearers and logical channels and various MAC functions (such as DRX and BSR and PHR and beam failure reporting etc) and various RRC functions (such as RRM and RLM and measurement etc) are configured.

The base station and the UE perform data transfer 2A91 via the established radio bearers and based on configured MAC functions and configured RRC functions.

If geographical location of UE changes such that e.g. the current serving cell is no longer providing suitable radio condition, the base station and the UE perform cell level mobility such as handover or conditional reconfiguration or lower layer triggered mobility.

When RRC connection is not longer needed for the UE because of e.g. no more traffic available for the UE, the base station and the UE performs RRC connection release procedure 2A101. The base station can transit UE state either to RRC_IDLE (if the data activity of the UE is expected low) or to RRC_INACTIVE (if the data activity of the UE is expected high).

The UE performs either RRC_IDLE operation or RRC_INACTIVE mode operation 2A111 until the next event to RRC connection establishment/resumption occurs.

FIG. 2B illustrates the operation of the UE regarding PLMN selection and cell selection and cell reselection.

For PLMN selection, the UE may scan all RF channels to find available PLMNs 2B11. On each carrier, the UE shall search for the strongest cell and read its system information 2B21, in order to find out which PLMN(s) the cell belongs to. Each found PLMN is considered as a high quality PLMN (but without the RSRP value) provided that the measured RSRP value is greater than or equal to −110 dBm.

The search for PLMNs may be stopped when the PLMN to which the UE can register is found 2B31.

Once the UE has selected a PLMN, the cell selection procedure shall be performed in order to select a suitable cell of that PLMN to camp on.

The UE performs measurement on detectable cells and receives system information from whichever detectable cells that system information is readable 2B41.

The UE consider cell selection criterion S is fulfilled when:
Srxlev>0 AND

### Squal>0

where, Srxlev is Cell selection RX level value (dB) and Squal is Cell selection quality value (dB). Srxlev is determined based on Measured cell RX level value (RSRP). Squal is determined based on Measured cell quality value (RSRQ).

The UE selects the cell that is part of the selected PLMN, and for which cell selection criteria are fulfilled, and of which cell access is not barred 2B51.

The UE camps on the selected cell. The UE perform RRC_IDLE mode operation 2B61 such as monitoring control channels to receive system information and paging and notification message.

FIG. 2C illustrates RRC connection establishment procedure.

Successful RRC connection establishment procedure comprises:
>1: transmission of RRCSetupRequest by the UE 2C11;
>1: reception of RRCSetup by the UE 2C21;
>1: transmission of RRCSetupComplete by the UE 2C31.
Unsuccessful RRC connection establishment procedure comprises:
>1: transmission of RRCSetupRequest by the UE 2C41;
>1: reception of RRCReject by the UE 2C51;
RRCSetupRequest comprises following fields and IEs:
>1: ue-Identity field contains InitialUE-Identity IE which contains:
>>2: ng-5G-S-TMSI-Part1 field containing a BIT STRING of 39 bit;
>1: establishmentCause field contains EstablishmentCause IE which contains:
>>2 enumerated value indicating either emergency, highPriorityAccess, mt-Access, mo-Signalling, mo-Data, mo-VoiceCall, mo-VideoCall, mo-SMS, mps-PriorityAccess, mcs-PriorityAccess etc
RRCSetup comprises following fields and IEs:
>1: radioBearerConfig field containing a RadioBearerConfig IE;
>1: masterCellGroup field containing a CellGroupConfig IE.
RRCSetupComplete comprises following fields and IEs:
>1: selectedPLMN-Identity field containing an integer indicating selected PLMN;
>1: dedicatedNAS-Message field containing a DedicatedNAS-Message which may contain various NAS message;
>1: ng-5G-S-TMSI-Part2 field containing a BIT STRING of 9 bit.

RRCSetupRequest is transmitted via CCCH/SRB0, which means that the base station does not identify UE transmitting the message based on DCI that scheduling the uplink transmission. The UE includes a field (ue-Identity) in the message so that the base station identify the UE. If 5G-S-TMSI is available (e.g. UE has already registered to a PLMN), the UE sets the field with part of the 5G-S-TMSI. If 5G-S-TMSI is not available (e.g. UE has not registered to any PLMN), the UE sets the field with 39-bit random value.

Upon reception of RRCSetup, UE configures cell group and SRB1 based on the configuration information in the RRCSetup. The UE perform following actions:
>1: perform the cell group configuration procedure in accordance with the received masterCellGroup;
>1: perform the radio bearer configuration procedure in accordance with the received radioBearerConfig;
>1: if stored, discard the cell reselection priority information provided by the cellReselectionPriorities or inherited from another RAT;
>1: enter RRC_CONNECTED;
>1: stop the cell re-selection procedure;
>1: consider the current cell to be the PCell;
The UE transmits to the base station RRCSetupComplete after performing above actions.
The UE sets the contents of RRCSetupComplete message as follows:
>1: set the ng-5G-S-TMSI-Value to ng-5G-S-TMSI-Part2;
>1: set the selectedPLMN-Identity to the PLMN selected by upper layers from the plmn-IdentityInfoList;
>1: include the s-NSSAI-List and set the content to the values provided by the upper layers;

FIG. 2D illustrates UE capability transfer procedure.

For network to configure the UE with appropriate configurations, the network needs to know the capability of the UE. For this end, the UE and the base station perform UE capability transfer procedure.

UE capability transfer procedure consists of exchanging UECapabilityEnquiry 2D11 and UECapabilityInformation 2D21 between the UE and the base station.

In the UECapabiliityEnquiry, the base station indicates which RAT is subject to capability reporting. UE transmits the capability information for the requested RAT in the UECapabilityInformation.

Once UECapabilityInformation is received, the capability information is uploaded to the AMF by the base station 2D31. When UE capability information is needed afterward, AMF provide it to the base station 2D41.

FIG. 2E illustrates RRC connection reconfiguration procedure.

Based on the reported capability and other factors such as required QoS and call admission control etc, the base station performs RRC reconfiguration procedure with the UE.

RRC reconfiguration procedure is a general purposed procedure that are applied to various use cases such as data radio bearer establishment, handover, cell group reconfiguration, DRX configuration, security key refresh and many others.

RRC reconfiguration procedure consists of exchanging RRCReconfiguration 2E11 and RRCReconfigurationComplete 2E61 between the base station and the UE. RRCReconfiguration may comprises following fields and IEs:
>1: rrc-TransactionIdentifier field contains a RRC-TransactionIdentifier IE;
>1: radioBearerConfig field contains a RadioBearerConfig IE;
>>2: radioBearerConfig field comprises configuration information for SRBs and DRBs via which RRC messages and user traffic are transmitted and received;
>1: secondaryCellGroup field contains a CellGroupConfig IE;
>>2: secondaryCellGroup field comprises configuration information for secondary cell group;
>>2: A cell group consists of a SpCell and zero or more SCells;
>>2: Cell group configuration information comprises cell configuration information for SpCell/SCell and configuration information for MAC and configuration information for logical channel etc;
>1: measConfig field contains a MeasConfig IE;
>>2: measConfig field comprises configuration information for measurements that the UE is required to perform for mobility and other reasons.
>1: masterCellGroup field contains a CellGroupConfig IE;
Upon reception of RRCReconfiguration, UE processes the IEs in the order as below.
UE may:
>1: perform the cell group configuration for MCG based on the received masterCellGroup 2E21;
>1: perform the cell group configuration for SCG based on the received secondaryCellGroup 2E31;
>1: perform the radio bearer configuration based on the received radioBearerConfig 2E41;
>1: perform the measurement configuration based on the received measConfig 2E51;
After performing configuration based on the received IEs/fields, the UE transmits the RRCReconfigurationComplete to the base station. To indicate that the RRCReconfigurationComplete is the response to RRCReconfiguration, UE sets the TransactionIdentifier field of the RRCReconfigurationComplete with the value indicated in TransactionIdentifier field of the RRCReconfiguration.

FIG. 2F illustrates data transfer procedure in RRC_CONNECTED state.

The UE and the base station may perform procedures for power saving such as C-DRX 2F11. The configuration information for C-DRX is provided to the UE within cell group configuration in the RRCReconfiguration.

The UE and the base station may perform various procedures for downlink scheduling 2F21 such as CSI reporting and beam management. The configuration information for CSI reporting is provided to the UE within cell group configuration in the RRCReconfiguration. Beam management is performed across RRC layer and MAC layer and PHY layer. Beam related information is configured via cell group configuration information within RRCReconfiguration. Activation and deactivation of beam is performed by specific MAC CEs.

Based on the reported CSI and downlink traffic for the UE, the base station determines the frequency/time resource and transmission format for downlink transmission. The base station transmits to the UE DCI containing downlink scheduling information via PDCCH 2F31. The base station transmits to the UE PDSCH corresponding to the DCI and containing a MAC PDU 2F41.

The UE and the base station may perform various procedure for uplink scheduling 2F51 such as buffer status reporting and power headroom reporting and scheduling request and random access. The configuration information for those procedures are provided to the UE in cell group configuration information in RRCReconfiguration.

Based on the uplink scheduling information reported by the UE, the base station determines the frequency/time resource and transmission format for uplink transmission. The base station transmits to the UE DCI containing uplink scheduling information via PDCCH 2F61. The base station transmits to the UE PDSCH corresponding to the DCI and containing a MAC PDU 2F71.

FIG. 2G illustrates random access procedure.

Random access procedure enables the UE to align uplink transmission timing, and indicate the best downlink beam, and transmit a MAC PDU that may contain CCCH SDU (e.g. RRCSetupRequest).

Random access procedure comprises preamble transmission 2G21, random access response reception 2G31, Msg 3 transmission 2G41 and contention resolution 2G51.

Parameters for random access procedure are provided in SIB1 (in case of initial access) or in RRCReconfiguration (in case of handover) 2G11.

Random access procedure may be triggered by a number of events such as initial access from RRC_IDLE (e.g. RRC connection establishment procedure), DL or UL data arrival, request by RRC upon synchronous reconfiguration (e.g. handover) and RRC Connection Resume procedure from RRC_INACTIVE etc.

When the random access procedure is initiated, the UE may perform following actions in order:
>1: flush the buffer for Msg 3;
>1: initialize the counters for preamble transmission and power ramping;
>1: select the uplink carrier for performing the random access procedure based on a rsrp threshold (e.g. rsrp-ThresholdSSB-SUL);
>1: select the set of Random Access resources applicable to the current Random Access procedure;
>1: select a SSB based on a rsrp threshold (e.g. rsrp-ThresholdSSB); a SSB corresponds to a downlink beam;
>1: select a random access preamble group based on the pathloss of the selected SSB and the potential Msg3 size and various parameters (e.g. ra-Msg3SizeGroupA, preambleReceivedTargetPower, msg3-DeltaPreamble, messagePowerOffsetGroupB etc); Preamble group selection enables the UE to request bigger uplink grant for Msg 3 transmission if channel condition is good enough and the potential Msg 3 size is above a certain threshold;
>1: select a random access preamble randomly with equal probability from the random access preambles associated with the selected SSB and the selected random access preamble group;
>1: determine the next available PRACH occasion from the PRACH occasions corresponding to the selected SSB;
>1: determine the transmission power of the preamble;

$$\text{>>2} : preamble transmission power = pathloss + preambleReceivedTargetPower + DELTA\_PREAMBLE + ( PREAMBLE\_POWER \_RAMPING \_COUNTER - 1 ) \times PREAMBLE\_POWER \_RAMPING \_STEP + POWER\_OFFSET \_ 2 STEP\_RA$$

>1: transmit the preamble in the determined PRACH occasion with the determined transmission power;
>1; start ra-Response Window;
>1: monitor the PDCCH of the SpCell for Random Access Response(s) identified by the RA-RNTI while the ra-Response Window is running;
>1: receive Random Access Response contains a MAC subPDU with Random Access Preamble identifier corresponding to the transmitted preamble;
>1: process the received Timing Advanced Command and the received UL grant;
>1: transmit a Msg 3 based on the received UL grant;
>>2: Msg 3 may contain e.g. CCCH SDU such as RRCSetupRequest or RRCResumeRequest;
>1: start ra-ContentionResolutionTimer;
>1: monitor the PDCCH while the ra-ContentionResolutionTimer is running;
>1: consider Contention Resolution successful when MAC PDU containing a UE Contention Resolution Identity MAC CE is received;
>1: consider the Random Access procedure successfully completed.

FIG. 2H illustrates scheduling request procedure based on dedicate scheduling request resource.

Unlike downlink traffic, the scheduler in the base station does not know when UE needs to be scheduled for uplink transmission. To enable uplink scheduling, the UE can be configured with scheduling request resource. When uplink resource is required for the UE, the UE can transmit a one-bit signal on the scheduling request resource based on the scheduling request procedure.

The base station provides to the UE configuration information for dedicate scheduling request procedure in RRCReconfiguration 2H11.

The configuration information comprises four main components: mapping information between events and the counter/timer/time resource/frequency resource, configuration information for counter/timer, configuration information for time resource, and configuration information for frequency resource.

One or more instances of configuration information on counter/timer (e.g. SchedulingRequestToAddMod) can be provided to the UE; each of them is associated with an identifier (e.g.schedulingRequestId). An initial value for counter (e.g. sr-TransMax) defines the number of consecutive times for SR transmission that is allowed. The timer (sr-Prohibittimer) defines the minimum time duration between the consecutive SR transmission.

One or more instances of configuration information on scheduling request resource (e.g. SchedulingRequestResourceConfig) can be provided to the UE; each of them is associated with an identifier (schedulingRequestID). The configuration information further comprises time domain information for the resource (e.g. periodicityAndOffset) and the identifier of the associated timer/counter (schedulingRequestResourceId) and the identifier of the associated frequency domain resource (PUCCH-ResourceId).

One or more instances of configuration information on PUCCH resource (e.g. PUCCH-Resource) can be provided to the UE; each of them is associated with an identifier (e.g. PUCCH-ResourceId). The configuration information comprises identifier of PRB where the PUCCH resource starts and an indication whether intra-slot frequency hopping is enabled.

The base station can indicate UE which counter/timer shall be used for which SR triggering event by binding the SR triggering event with a schedulingRequestId.

SR triggering event can be: data arrival in logical channel, SCell beam failure recovery, positioning measurement gap activation/deactivation request etc.

When an SR triggering event occurs 2H21, the UE determines the associated counter/timer based on the mapping information between SR triggering event and schedulingRequestId. Based on the determined schedulingRequestID, the UE determines the associated PUCCH-Resource and the associated SchedulingRequestResource 2H31; more specifically, the UE determines that the SchedulingRequestResource of which configuration information comprises schedulingRequestID is the SchedulingRequestResource associated with the timer/counter identified by the schedulingRequestID.

The UE transmits the SR 2H41:
>1: in the time/frequency resource determined from SchedulingRequestResource associated with the schedulingRequestId; and
>1: based on the prohibit timer and the initial counter value determined from the schedulingRequestId.

SchedulingRequestToAddMod and SchedulingRequestResource have one to one relationship between them.

FIG. 2I illustrates buffer status reporting procedure.

Unlike downlink traffic, the scheduler in the base station does not know when and how much and how important data arrives in the UE. To provide information on buffer status, the UE may transmit a Buffer Status Report (BSR) MAC CE when deemed triggered. BSR MAC CE comprises one or more Buffer Size field, each of which indicates the amount of data available for transmission across logical channels of a logical channel group.

The base station provides a BSR configuration via a dedicate RRC message such as RRCReconfiguration 2111. The BSR configuration comprises a timer controlling periodic reporting and other information. The mapping information between a logical channel and a logical channel group is also provided in the dedicate RRC message.

BSR can be triggered event-driven or periodically or based on padding. Upon a significant event that cause buffer status change or upon expiry of a timer or upon space for padding being available, BSR is triggered 2121.

A BSR shall be triggered if any of the following events occur for activated cell group:
>1: UL data, for a logical channel which belongs to an LCG, becomes available to the MAC entity; and either
>>2: this UL data belongs to a logical channel with higher priority than the priority of any logical channel containing available UL data which belong to any LCG; or
>>2: none of the logical channels which belong to an LCG contains any available UL data.
>1: in which case the BSR is referred below to as ‘Regular BSR’;
>1: UL resources are allocated and number of padding bits is equal to or larger than the size of the Buffer Status Report MAC CE plus its subheader, in which case the BSR is referred below to as ‘Padding BSR’;
>1: retxBSR-Timer expires, and at least one of the logical channels which belong to an LCG contains UL data, in which case the BSR is referred below to as ‘Regular BSR’;
>1: periodicBSR-Timer expires, in which case the BSR is referred below to as ‘Periodic BSR’.

The UE determines the format of the BSR depending on which event triggers the BSR 2131.

Based on the number of logical channel groups with data available for transmission, a short format and a long format are defined.

Based on whether all logical channels can be reported or not, a truncated format and the normal/full format are defined.

Short BSR and Short Truncated BSR comprise following fields:
>1: LCG ID field indicates the identifier of LCG whose buffer status is being reported.
>1: short Buffer Size field indicates the total amount of data available across all logical channels of a logical channel group. The amount of data is indicated in number of bytes. The length of this field is 5 bit.

Long BSR and Long Truncated BSR comprises following fields:
>1: Bitmap field comprises 8 bit. Each bit indicates the presence of the Buffer Size field for the corresponding logical channel group;
>1: long Buffer Size field indicates the total amount of data available across all logical channels of a logical channel group. The amount of data is indicated in number of bytes. The length of this field is 8 bit.

In principle, since the information contained in BSR triggered due to new uplink data or timer expiry is crucial for uplink scheduling, BSR format is determined solely based on the number of LCGs for reporting. On the other hands, the information contained in BSR triggered due to padding is supplementary information for uplink scheduling, BSR format is determined based on the number of LCGs and the size of padding space.

The UE transmits a Short BSR in the following case:
>1: only one LCG has data available for transmission and the BSR is triggered due to new uplink data or timer expiry; or
>1 only one LCG has data available for transmission and the size of padding is enough to accommodate the Short BSR.

The UE transmits a Short Truncated BSR in the following case:
>1: padding occurs (e.g. MAC SDUs or MAC CEs do not fill up all the available space of MAC PDU); and
>1: more than one LCG have data available for transmission; and
>1: the size of padding is not enough to accommodate a Long BSR or a Long Truncated BSR but enough to accommodate the Short Truncated BSR.

The UE transmits a Long BSR in the following case:
>1: more than one LCGs have data available for transmission and the BSR is triggered due to new uplink data or timer expiry.

The UE transmits a Long Truncated BSR in the following case:
>1: padding occurs; and
>1: more than one LCG have data available for transmission; and
>1: the size of padding is not enough to accommodate a Long BSR but enough to a Long Truncated BSR.

The UE transmits BSR 2141. To get the uplink resource for BSR transmission, if the BSR is triggered for new uplink data that is important than what are stored previously, scheduling request procedure can be initiated beforehand.

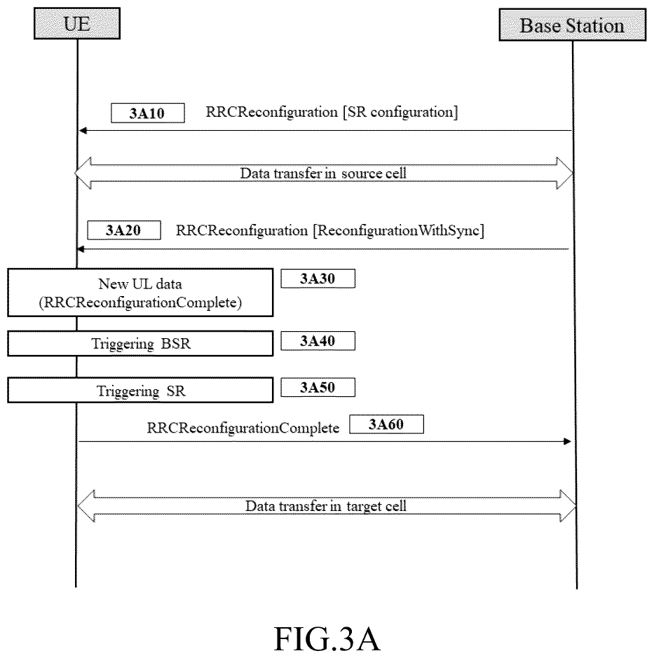

FIG. 3A illustrates operation of UE and base station for handover from source cell to target cell.

At 3A10, the base station transmits to the UE in a source cell a first RRCReconfiguration message that comprises various configuration information such as SR configuration information.

UE and the base station perform data transfer in the source cell.

At some point of time, the base station decides to perform handover the UE from the source cell to the target cell. GNB may also determine the type of handover based on consideration on various facts such as UE capability, radio condition and amount of load etc.

At 3A20, the base station transmits to the UE in the source cell a second RRCReconfiguration message that comprises Reconfiguration WithSync IE.

Depending on the type of the handover, Reconfiguraiton WithSync IE may comprise various configuration parameters. If the handover is to be performed with random access procedure in the target cell, the ReconfigurationWithSync IE comprises parameters for random access procedure in the target cell. If the handover is to be performed without random access procedure in the target cell, the Reconfiguration WithSync IE comprises parameters for uplink timing adjustment to be applied in the target cell.

At 3A30, UE generates RRCReconfigurationComplete message. It means new uplink data occurs for SRB1.

At 3A40, UE triggers regular BSR to report to the base station amount of new data in the SRB1.

At 3A50, UE triggers SR based on the SR configuration information if at least one of certain conditions is met.

UE determines whether to transmit SR or to initiate random access procedure or to perform neither. If handover with random access is configured, UE initiates random access procedure. Random access procedure in this case is initiated since valid SR is not available yet (since MAC reset has been performed before generating RRCReconfigurationComplete message, uplink synchronization is not maintained which leads to that only preamble transmission is possible). If handover without random access is configured and if configured grant is not configured, UE may transmit SR if SR is configured in the target cell. In this case, uplink synchronization is recovered when uplink timing adjustment is applied in the target cell. If handover without random access is configured and if configured grant is configured, UE may perform neither. In this case, uplink resource to transmit the BSR is already available which makes SR transmission unnecessary.

At 3A60, UE and the base station performs data transfer in the target cell.

After receiving RRCReconfiguration message that comprises Reconfiguration WithSync; and
before generating RRCReconfigurationComplete message,
UE may:
>1: start timer T304 for the corresponding SpCell with the timer value set to t304, as included in the reconfiguration WithSync;
>1: if the frequencyInfoDL is included:
>>2: consider the target SpCell to be one on the SSB frequency indicated by the frequencyInfoDL with a physical cell identity indicated by the physCellId;
>1: if the frequencyInfoDL is not included:
>>2: consider the target SpCell (special cell; either PCell or PSCell) to be one on the SSB frequency of the source SpCell with a physical cell identity indicated by the physCellId;
>1: start synchronising to the DL of the target SpCell;
>1: apply the specified BCCH configuration defined in 9.1.1.1 for the target SpCell;
>1: acquire the MIB of the target SpCell;
>1: if NTN-Config is configured for the target cell:
>>2: start timer T430 with the timer value set to ntn-UlSync ValidityDuration from the subframe indicated by epochTime, according to the target cell NTN-Config;
>1: reset the MAC entity of this cell group;
>1: consider the SCell(s) of this cell group, if configured, that are not included in the SCellToAddModList in the RRCReconfiguration message, to be in deactivated state;
>1: apply the value of the newUE-Identity as the C-RNTI for this cell group;
>1: configure lower layers in accordance with the received spCellConfigCommon;
>1: if rach-LessHO is included:
>>2: configure lower layers in accordance with rach-LessHO for the target SpCell;
>1: configure lower layers in accordance with any additional fields, not covered in the previous, if included in the received reconfiguration WithSync.

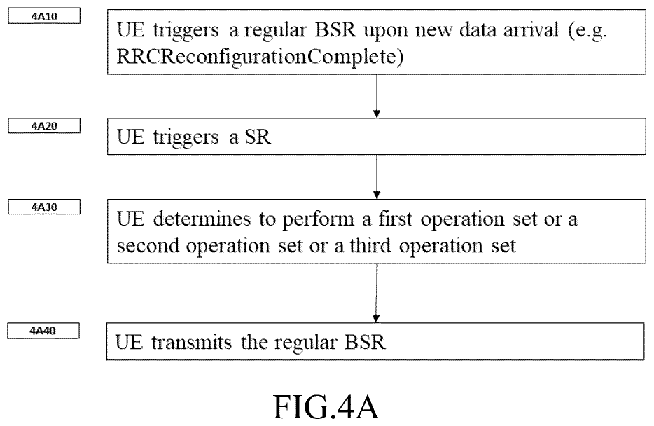

FIG. 4A illustrates operation of terminal.

UE may perform following operation when an uplink RRC message is generated.

At 4A10. UE triggers a regular BSR upon new data arrival (e.g. RRCReconfigurationComplete) in case that:
>1: UL data, for a logical channel which belongs to an LCG, becomes available to the MAC entity; and either
>>2: this UL data belongs to a logical channel with higher priority than the priority of any logical channel containing available UL data which belong to any LCG; or
>>2: none of the logical channels which belong to an LCG contains any available UL data.

At 4A20, UE triggers a SR in case that:
>1: a Regular BSR has been triggered and logicalChannelSR-DelayTimer is not running:
>>2: there is no UL-SCH resource available for a new transmission; or
>>2: the MAC entity is configured with configured uplink grant(s) and the Regular BSR was triggered for a logical channel for which logicalChannelSR-Mask is set to false; or
>>2: the UL-SCH resources available for a new transmission do not meet the LCP mapping restrictions configured for the logical channel that triggered the BSR.

At 4A30, UE determines to perform a first operation set or a second operation set or a third operation set.

At 4A40, UE transmits the regular BSR.

UE performs a first operation set if RACH-LessHO IE is configured (while t304 is running);
>1: perform a second operation set if:
>>2: RACH-LessHO IE is not configured (e.g. the current time is not the first period); and
>>2: no valid PUCCH resource configured for the pending SR is available;
>1: perform a third operation set in case that:
>>2: RACH-LessHO IE is not configured (e.g. the current time is not the first period); and
>>2: SR transmission occasion on the valid PUCCH resource for SR is configured. Alternatively, UE may:
>1: perform a first operation set if the current time is not a first period;
>>2: t304 is running, wherein t304 is indicated in the Reconfiguration WithSync; and
>>2 t304 has started due to reception of RRCReconfiguration that contains RACH-LessHO IE;
>1: perform a second operation set if:
>>2: the current time is not the first period; and
>>2: no valid PUCCH resource configured for the pending SR is available;
>1: perform a third operation set if:
>>2: the current time is not the first period and valid PUCCH resource configured for the pending SR is valid and SR transmission occasion on the valid PUCCH resource for SR is configured; or
>>2: the current time is the first period and valid PUCCH resource configured for the pending SR is valid and SR transmission occasion on the valid PUCCH resource for SR is configured.

For the first operation set, UE may:
>1: cancel the pending SR; or
>1: suspend the pending SR until the first period ends.

For the second operation set, UE may:
>1: initiate a Random Access procedure on the SpCell and cancel the pending SR.

For the third operation set, UE may, when the MAC entity has an SR transmission occasion on the valid PUCCH resource for SR configured:
>1: if sr-ProhibitTimer is not running at the time of the SR transmission occasion; and
>1: if the PUCCH resource for the SR transmission occasion does not overlap with a measurement gap:
>>2: if the PUCCH resource for the SR transmission occasion overlaps with neither a UL-SCH resource whose simultaneous transmission with the SR is not allowed by configuration of simultaneousPUCCH-PUSCH or simultaneousPUCCH-PUSCH-SecondaryPUCCHgroup or simultaneousSR-PUSCH-diffPUCCH-Groups nor an SL-SCH resource; or
>>2: if the MAC entity is able to perform this SR transmission simultaneously with the transmission of the SL-SCH resource; or
>>2: if the MAC entity is configured with Ich-basedPrioritization, and the PUCCH resource for the SR transmission occasion does not overlap with the PUSCH duration of an uplink grant received in a Random Access Response or with the PUSCH duration of an uplink grant addressed to Temporary C-RNTI or with the PUSCH duration of a MSGA payload, and the PUCCH resource for the SR transmission occasion for the pending SR triggered as specified in clause 5.4.5 overlaps with any other UL-SCH resource(s), and the physical layer can signal the SR on one valid PUCCH resource for SR, and the priority of the logical channel that triggered SR is higher than the priority of the uplink grant(s) for any UL-SCH resource(s) where the uplink grant was not already de-prioritized and its simultaneous transmission with the SR is not allowed by configuration of simultaneousPUCCH-PUSCH or simultaneousPUCCH-PUSCH-SecondaryPUCCHgroup or simultaneousSR-PUSCH-diffPUCCHgroups, and the priority of the uplink grant is determined as specified in clause 5.4.1; or
>>2: if both sl-PrioritizationThres and ul-PrioritizationThres are configured and the PUCCH resource for the SR transmission occasion for the pending SR triggered as specified in clause 5.22.1.5 overlaps with any UL-SCH resource(s) carrying a MAC PDU, and the value of the priority of the triggered SR determined as specified in clause 5.22.1.5 is lower than sl-PrioritizationThres and the value of the highest priority of the logical channel(s) in the MAC PDU is higher than or equal to ul-PrioritizationThres and any MAC CE prioritized as described in clause 5.4.3.1.3 is not included in the MAC PDU and the MAC PDU is not prioritized by upper layer according to TS 23.287 [19]; or
>>2: if an SL-SCH resource overlaps with the PUCCH resource for the SR transmission occasion for the pending SR triggered as specified in clause 5.4.5, and the MAC entity is not able to perform this SR transmission simultaneously with the transmission of the SL-SCH resource, and either transmission on the SL-SCH resource is not prioritized as described in clause 5.22.1.3.1a or the priority value of the logical channel that triggered SR is lower than ul-PrioritizationThres, if configured; or
>>2: if an SL-SCH resource overlaps with the PUCCH resource for the SR transmission occasion for the pending SR triggered as specified in clause 5.22.1.5, and the MAC entity is not able to perform this SR transmission simultaneously with the transmission of the SL-SCH resource, and the priority of the triggered SR determined as specified in clause 5.22.1.5 is higher than the priority of the MAC PDU determined as specified in clause 5.22.1.3.1a for the SL-SCH resource:
>>>3: consider the SR transmission as a prioritized SR transmission.
>>>3: consider the other overlapping uplink grant(s), if any, as a de-prioritized uplink grant(s), except for the overlapping uplink grant(s) whose simultaneous transmission is allowed by configuration of simultaneousPUCCH-PUSCH or simultaneousPUCCH-PUSCH-SecondaryPUCCHgroup or simultaneousSR-PUSCH-diffPUCCH-Groups;
>>>3: if the de-prioritized uplink grant(s) is a configured uplink grant configured with autonomousTx whose PUSCH has already started:
>>>>4: stop the configuredGrantTimer for the corresponding HARQ process of the de-prioritized uplink grant(s);
>>>>4: stop the cg-RetransmissionTimer for the corresponding HARQ process of the de-prioritized uplink grant(s).
>>>3: if SR_COUNTER<sr-TransMax:
>>>>4: instruct the physical layer to signal the SR on one valid PUCCH resource for SR;
>>>>4: if LBT failure indication is not received from lower layers:
>>>>>5: increment SR_COUNTER by 1;
>>>>>5: start the sr-ProhibitTimer.
>>>>4: else if lbt-FailureRecoveryConfig is not configured:
>>>>>5: increment SR_COUNTER by 1.
>>>3: else:
>>>>4: notify RRC to release PUCCH for all Serving Cells;
>>>>4: notify RRC to release SRS for all Serving Cells;
>>>>4: clear any configured downlink assignments and uplink grants;
>>>>4: clear any PUSCH resources for semi-persistent CSI reporting;
>>>>4: initiate a Random Access procedure (see clause 5.1) on the SpCell and cancel all pending SRs.
>>2: else:
>>>3: consider the SR transmission as a de-prioritized SR transmission.

ReconfigurationWithSync in 5G NR (New Radio) includes various types of information for synchronous reconfiguration such as handover. The IE may comprises:
>1: Target Cell Information: This includes details about the target cell, such as cell identity and frequency. This information is essential for the UE to identify and synchronize with the target cell.
>1: Timing Advance: This includes the timing advance value that the UE needs to apply to align its transmission timing with the target cell.
>1: RACH (Random Access Channel) Configuration: This includes parameters for the RACH procedure, such as preamble format and power control. RACH configuration is important for the UE to successfully access the target cell.

More specifically, the Reconfiguration WithSync comprises following IEs/fields.

| | |
|---|---|
| ReconfigurationWithSync ::= | SEQUENCE { |
| spCellConfigCommon | ServingCellConfigCommon |

OPTIONAL, -- Need M

| | |
|---|---|
| newUE-Identity | RNTI-Value, |
| t304 | ENUMERATED {ms50, ms100, |

ms150, ms200, ms500, ms1000, ms2000, ms10000},

| | |
|---|---|
| rach-ConfigDedicated | CHOICE { |
| uplink | RACH-ConfigDedicated, |
| supplementaryUplink | RACH-ConfigDedicated |

```
    }
OPTIONAL, -- Need N
    ...,
    [[
```

| | |
|---|---|
| smtc | SSB-MTC |

```
OPTIONAL -- Need S
    ]],
    [[
```

| | |
|---|---|
| daps-UplinkPowerConfig-r16 | DAPS-UplinkPowerConfig-r16 |

```
OPTIONAL -- Need N
    ]],
    [[
```

| | |
|---|---|
| sl-PathSwitchConfig-r17 | SL-PathSwitchConfig-r17 |

```
OPTIONAL -- Cond DirectToIndirect-PathSwitch
    ]],
    [[
```

| | |
|---|---|
| rach-LessHO-r18 | RACH-LessHO-r18 |

OPTIONAL, -- Need N

| | |
|---|---|
| sl-IndirectPathMaintain-r18 | ENUMERATED{true} |

```
OPTIONAL -- Cond MP
    ]]
  }
```

ssb-Index field indicates a beam that the UE should use in the target cell to monitor PDCCH for initial uplink transmission The network configures this field when dynamic grant is used for initial uplink transmission in RACH-less handover in NTN.

targetNTA refers to the timing adjustment indicating the NTA value which the UE shall use for the target PTAG of handover. The value zero corresponds to NTA-0, while the value source corresponds to the NTA value of the source PTAG indicated by the tag-Id.

tci-StateID field indicates a beam that the UE should use in the target cell to monitor PDCCH for initial uplink transmission and also indicates the TCI state information to be used in the target cell. The network configures this field in case this cell is a mobile IAB cell.

rach-ConfigDedicated field comprises random access configuration to be used for the reconfiguration with sync (e.g. handover). The UE performs the RA according to these parameters in the firstActiveUplinkBWP.

smtc field indicates SSB periodicity/offset/duration configuration of target cell for NR PSCell change and NR PCell change.

NTN-Config (Non-Terrestrial Network Configuration) in 5G NR includes various types of information and their roles are crucial for the proper functioning of non-terrestrial networks. It comprises following inforamtion:
>1: Orbit Information: This includes details about the satellite's orbit, such as altitude, inclination, and orbital period. This information is essential for determining the satellite's position and movement, which affects coverage and signal quality.
>1: Beam Information: This includes the configuration of the satellite beams, such as beam patterns, beamforming capabilities, and beam switching mechanisms. Beam information is critical for managing the coverage area and ensuring efficient use of the satellite's resources.
>1: Timing Information: This includes details about the timing synchronization between the satellite and the UE (User Equipment). Accurate timing information is necessary to maintain synchronization and avoid signal interference.
>1: Frequency Information: This includes the frequency bands used for communication between the satellite and the UE. Frequency information is important for avoiding interference with other communication systems and ensuring efficient spectrum utilization.
>1: Power Control Information: This includes parameters for controlling the transmission power of the satellite and the UE. Power control information is essential for maintaining signal quality and reducing interference with other users.

More specifically, NTN-Config IE comprises following IEs/fields.

| | |
|---|---|
| NTN-Config-r17 ::= | SEQUENCE { |
| epochTime-r17 | EpochTime-r17 |

OPTIONAL, -- Need R
ntn-UlSyncValidityDuration-r17 ENUMERATED{ s5, s10, s15, s20, s25, s30,
s35,

| | |
|---|---|
| | s40, s45, s50, s55, s60, |
| s120, s180, s240, s900} | OPTIONAL, -- Cond SIB 19 |
| cellSpecificKoffset-r17 | INTEGER(1..1023) |

OPTIONAL, -- Need R

| | |
|---|---|
| kmac-r17 | INTEGER(1..512) |

OPTIONAL, -- Need R

| | |
|---|---|
| ta-Info-r17 | TA-Info-r17 |

OPTIONAL, -- Need R

| | |
|---|---|
| ntn-PolarizationDL-r17 | ENUMERATED {rhcp,lhcp,linear} |

OPTIONAL, -- Need R

| | |
|---|---|
| ntn-PolarizationUL-r17 | ENUMERATED {rhcp,lhcp,linear} |

OPTIONAL, -- Need R

| | |
|---|---|
| ephemerisInfo-r17 | EphemerisInfo-r17 |

OPTIONAL, -- Need R

| | |
|---|---|
| ta-Report-r17 | ENUMERATED {enabled} |

```
OPTIONAL, -- Need R
    ...
  }
```

| | |
|---|---|
| TA-Info-r17 ::= | SEQUENCE { |
| ta-Common-r17 | INTEGER(0..66485757), |
| ta-CommonDrift-r17 | INTEGER(−257303..257303) |

OPTIONAL, -- Need R

| | |
|---|---|
| ta-CommonDriftVariant-r17 | INTEGER(0..28949) |

OPTIONAL -- Need R
}

EphemerisInfo field provides satellite ephemeris either in format of position and velocity state vector or in format of orbital parameters. This field is excluded when determining changes in system information, i.e. changes to ephemerisInfo should neither result in system information change notifications nor in a modification of valueTag in SIB1.

ntn-UlSync ValidityDuration indicates a validity duration configured by the network for assistance information (i.e. Serving and/or neighbour satellite ephemeris and Common TA parameters) which indicates the maximum time duration (from epochTime) during which the UE can apply assistance information without having acquired new assistance information.

The logicalChannelSR-DelayTimer is a parameterto delay the transmission of a Scheduling Request (SR) for a logical channel. The logicalChannelSR-DelayTimer starts when a Scheduling Request (SR) is triggered for a logical channel. This timer is included in the Buffer Status Report (BSR) configuration. Once the SR is triggered, the logicalChannelSR-DelayTimer activates and delays the transmission of the SR for the logical channel.

The logicalChannelSR-DelayTimer ends when the timer expires. If the timer expires without the SR being transmitted, the SR will be sent immediately after the timer ends. This mechanism helps in managing uplink resources more efficiently and avoids unnecessary SR transmissions.

The logicalChannelSR-Mask is a parameter to control the triggering of a Scheduling Request (SR) for a logical channel when it has a configured uplink grant of either Type 1 or Type 2. This parameter helps in managing the uplink resources more efficiently by preventing unnecessary SR transmissions when the logical channel already has an uplink grant allocated.

The t304 timer is a parameter to manage the handover procedure between cells. Specifically, the t304 timer is started when a handover command is received from the source cell. This timer defines the maximum time allowed for the UE (User Equipment) to complete the handover to the target cell. If the handover is not completed within the duration of the t304 timer, the handover procedure is considered to have failed, and the UE may take appropriate actions such as reattempting the handover or initiating a connection re-establishment procedure.

The sr-ProhibitTimer is a parameter to indicate the time in milliseconds (ms) that a UE (User Equipment) has to wait before it can transmit the next Scheduling Request (SR).

Logical Channel Prioritization (LCP) is a procedure to manage and prioritize data traffic over different logical channels. The main role of LCP is to ensure that high-priority data is given precedence over low-priority data, thereby improving the overall efficiency and Quality of Service (QOS) of the wireless network.

TAG consists of a group of serving cells that share the same timing advance value. Each TAG is identified by a unique identifier. Role: PTAG manages the timing advance for uplink transmissions. PTAG is TAG that comprises PCell and STAG is TAG that does not comprise PCell.

PUCCH (Physical Uplink Control Channel) is used to transmit uplink control information (UCI) from the user equipment (UE) to the gNodeB (base station). There are several PUCCH formats defined in NR, each designed to carry different types of control information. These formats vary in terms of the number of symbols and the type of modulation used. PUCCH resources are allocated in the frequency/time domain and can be dynamically assigned based on the network's requirements. PUCCH is primarily used to transmit UCI, which includes:
>1: Hybrid Automatic Repeat Request (HARQ) Acknowledgments: Feedback on the reception of downlink data packets.
>1: Scheduling Requests (SR): Requests for uplink resources.
>1: Channel State Information (CSI): Information about the channel conditions.

A Logical Channel Group (LCG) is a collection of logical channels that are grouped together for the purpose of resource allocation and management. Logical channels are used to carry different types of data, such as voice, video, and control signaling, between the base station and mobile devices.

Each logical channel within an LCG is associated with a specific type of data or service. Logical channels are categorized based on their QoS requirements and data characteristics.

Each LCG is identified by a unique identifier, which is used for resource allocation and scheduling purposes.

LCGs facilitate efficient resource allocation by grouping logical channels with similar QoS requirements. This allows the base station to allocate resources based on the aggregated needs of the LCG, rather than individual logical channels.

The UE periodically (or in event-driven manner) reports the buffer status of each LCG to the base station. This information is used by the base station to make informed decisions about resource allocation and scheduling.

The RRCReconfiguration message and the RRCReconfigurationComplete message are received and transmitted via a specific logical channel. The specific logical channel is dedicate control channel (DCCH) that is associated with signaling radio bearer 1 (SRB1).

Synchronous reconfiguration is a process where the terminal and the base station apply one or more parameters at the same time. Synchronous reconfiguration conventionally accompanies random access procedure to provide reference time for applying the parameters. Synchronous reconfiguration is applied to various procedures such as handover or secondary cell group change.

UE may perform followings:
>1: triggering a buffer status report (BSR) in case that uplink data for a specific logical channel becomes available;
>1: triggering a scheduling request (SR) in case that no uplink resource is available for new transmission;
>1: cancelling the SR without transmission of the SR in case that:
>>2: no valid PUCCH resource configured for the SR is available; and
>>2: a specific radio resource control (RRC) message does not comprise a specific set of parameters [RACH-less HO].

The specific set of parameters comprises at least a parameter related to timing adjustment for a specific set of serving cells [targetNTA].

The specific set of parameters further comprises a parameter related to beam for PDCCH monitoring.

The specific set of serving cells comprises one or more serving cells that use same timing reference cell.

The specific set of serving cells comprises a special cell and one or ore secondary cells.

The terminal does not cancel the SR in case that:
>1: no valid PUCCH resource configured for the SR is available; and
>1: a specific RRC message comprises a specific set of parameters.

The terminal cancels the SR after transmission of the SR in case that valid PUCCH resource configured for the SR is available.

Random access is initiated for the SR in case that:
>1: no valid PUCCH resource configured for the SR is available; and
>1: the specific RRC message does not comprise the specific set of parameters, Random access is not initiated for the SR in case that:
>1: no valid PUCCH resource configured for the SR is available; and
>1: the specific RRC message comprises the specific set of parameters.

The specific RRC message is a RRC message that comprises a set of parameters for synchronous reconfiguration. The specific RRC message is received by the terminal before the BSR is triggered.

The set of parameters for synchronous reconfiguration comprises:
>1: a field for random access configuration;
>1: a field for common configuration of a special cell;
>1: a field for a first timer;
>1: a field for a second timer [ntn-UlSync ValidityDuration]; and
>1: a field for the specific set of parameters.

The first timer starts in response to reception of the specific RRC message.

A target special cell is determined based on the frequency of a source special cell after the first timer starts.

The second timer starts after the target special cell is determined.

The terminal initiates:
>1: connection reestablishment procedure in case that the first timer expires; and
>1: acquisition of new assistance information in case that the second timer expires.

The specific logical channel is a logical channel configured for the specific RRC message.

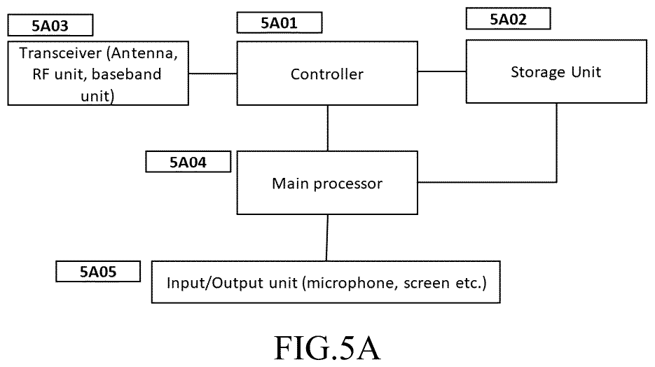

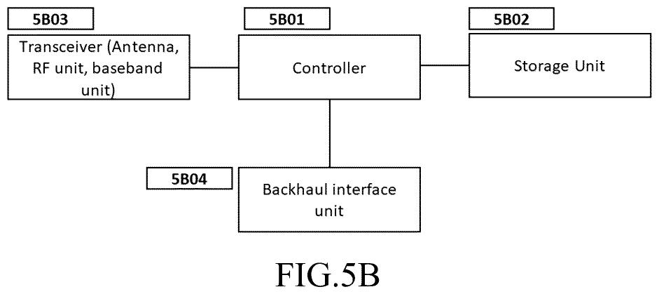

FIG. 5A is a block diagram illustrating the internal structure of a UE to which the disclosure is applied.

Referring to the diagram, the UE includes a controller 5A01, a storage unit 5A02, a transceiver 5A03, a main processor 5A04 and I/O unit 5A05.

The controller 5A01 controls the overall operations of the UE in terms of mobile communication. For example, the controller 5A01 receives/transmits signals through the transceiver 5A03. In addition, the controller 5A01 records and reads data in the storage unit 5A02. To this end, the controller 5A01 includes at least one processor. For example, the controller 5A01 may include a communication processor (CP) that performs control for communication and an application processor (AP) that controls the upper layer, such as an application program. The controller controls storage unit and transceiver such that UE operations illustrated in this disclosure are performed.

The storage unit 5A02 stores data for operation of the UE, such as a basic program, an application program, and configuration information. The storage unit 5A02 provides stored data at a request of the controller 5A01.

The transceiver 5A03 consists of a RF processor, a baseband processor and one or more antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mixer, an oscillator, a digital-to-analog converter (DAC), an analog-to-digital converter (ADC), and the like. The RF processor may perform MIMO and may receive multiple layers when performing the MIMO operation. The baseband processor performs a function of conversion between a baseband signal and a bit string according to the physical layer specification of the system. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The main processor 5A04 controls the overall operations other than mobile operation. The main processor 5A04 process user input received from I/O unit 5A05, stores data in the storage unit 5A02, controls the controller 5A01 for required mobile communication operations and forward user data to I/O unit 5A05.

I/O unit 5A05 consists of equipment for inputting user data and for outputting user data such as a microphone and a screen. I/O unit 5A05 performs inputting and outputting user data based on the main processor's instruction.

FIG. 5B is a block diagram illustrating the configuration of a base station according to the disclosure.

As illustrated in the diagram, the base station includes a controller 5B01, a storage unit 5B02, a transceiver 5B03 and a backhaul interface unit 5B04.

The controller 5B01 controls the overall operations of the main base station. For example, the controller 5B01 receives/transmits signals through the transceiver 5B03, or through the backhaul interface unit 5B04. In addition, the controller 5B01 records and reads data in the storage unit 5B02. To this end, the controller 5B01 may include at least one processor. The controller controls transceiver, storage unit and backhaul interface such that base station operation illustrated in this disclosure are performed.

The storage unit 5B02 stores data for operation of the main base station, such as a basic program, an application program, and configuration information. Particularly, the storage unit 5B02 may store information regarding a bearer allocated to an accessed UE, a measurement result reported from the accessed UE, and the like. In addition, the storage unit 5B02 may store information serving as a criterion to deter mine whether to provide the UE with multi-connection or to discontinue the same. In addition, the storage unit 5B02 provides stored data at a request of the controller 5B01.

The transceiver 5B03 consists of a RF processor, a baseband processor and one or more antennas. The RF processor performs functions for transmitting/receiving signals through a wireless channel, such as signal band conversion, amplification, and the like. Specifically, the RF processor up—converts a baseband signal provided from the baseband processor into an RF band signal, transmits the same through an antenna, and down—converts an RF band signal received through the antenna into a baseband signal. The RF processor may include a transmission filter, a reception filter, an amplifier, a mixer, an oscillator, a DAC, an ADC, and the like. The RF processor may perform a down link MIMO operation by transmitting at least one layer. The baseband processor performs a function of conversion between a baseband signal and a bit string according to the physical layer specification of the first radio access technology. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The backhaul interface unit 5B04 provides an interface for communicating with other nodes inside the network. The backhaul interface unit 5B04 converts a bit string transmitted from the base station to another node, for example, another base station or a core network, into a physical signal, and converts a physical signal received from the other node into a bit string.

Acronyms used in the present disclosure are as below.

| | | | |
|---|---|---|---|
| 5GC | 5G Core Network | RACH | Random Access Channel |
| ACK | Acknowledgement | RAN | Radio Access Network |
| AM | Acknowledged Mode | RAR | Random Access Response |
| AMF | Access and Mobility Management Function | | |
| RA-RNTI | Random Access RNTI | | |
| ARQ | Automatic Repeat Request | RAT | Radio Access Technology |
| AS | Access Stratum | RB | Radio Bearer |
| ASN.1 | Abstract Syntax Notation One | RLC | Radio Link Control |
| BSR | Buffer Status Report | RNA | RAN-based Notification Area |
| BWP | Bandwidth Part | RNAU | RAN-based Notification Area Update |
| CA | Carrier Aggregation | RNTI | Radio Network Temporary Identifier |
| CAG | Closed Access Group | RRC | Radio Resource Control |
| CG | Cell Group | RRM | Radio Resource Management |
| C-RNTI | Cell RNTI | RSRP | Reference Signal Received Power |
| CSI | Channel State Information | RSRQ | Reference Signal Received Quality |
| DCI | Downlink Control Information | RSSI | Received Signal Strength Indicator |
| DRB | (user) Data Radio Bearer | SCell | Secondary Cell |
| DTX | Discontinuous Reception | SCS | Subcarrier Spacing |
| HARQ | Hybrid Automatic Repeat Request | | |
| SDAP | Service Data Adaptation Protocol | | |
| IE | Information element | SDU | Service Data Unit |
| LCG | Logical Channel Group | SFN | System Frame Number |
| MAC | Medium Access Control | S-GW | Serving Gateway |
| MIB | Master Information Block | SI | System Information |
| NAS | Non-Access Stratum | SIB | System Information Block |
| NG-RAN | NG Radio Access Network | SpCell | Special Cell |
| NR | NR Radio Access | SRB | Signalling Radio Bearer |
| PBR | Prioritised Bit Rate | SRS | Sounding Reference Signal |
| PCell | Primary Cell | SS | Search Space |
| PCI | Physical Cell Identifier | SSB | SS/PBCH block |
| PDCCH | Physical Downlink Control Channel | | |
| SSS | Secondary Synchronisation Signal | | |
| PDCP | Packet Data Convergence Protocol | SUL | Supplementary Uplink |
| PDSCH | Physical Downlink Shared Channel | | |
| TM | Transparent Mode | | |
| PDU | Protocol Data Unit | UCI | Uplink Control Information |
| PHR | Power Headroom Report | UE | User Equipment |
| PLMN | Public Land Mobile Network | UM | Unacknowledged Mode |
| PRACH | Physical Random Access Channel | | |
| CRP | Cell Reselection Priority | | |
| PRB | Physical Resource Block | PSS | Primary Synchronisation Signal |
| PUCCH | Physical Uplink Control Channel | | |
| PUSCH | Physical Uplink Shared Channel | | |

What is claimed is:

1. A method by a terminal, the method comprising:
triggering a buffer status report (BSR) in case that uplink data for a specific logical channel becomes available;
triggering a scheduling request (SR) in case that no uplink resource is available for new transmission; and
cancelling the SR without transmission of the SR in case that:
no valid PUCCH resource configured for the SR is available; and
a specific radio resource control (RRC) message does not comprise a specific set of parameters,
wherein the specific set of parameters comprises a parameter related to beam for physical downlink control channel (PDCCH) monitoring.

2. The method of the claim 1,
wherein the specific set of parameters further comprises a parameter related to timing adjustment for a specific set of serving cells.

3. The method of claim 2, wherein:
the specific set of serving cells comprises one or more serving cells that use same timing reference cell; and
the specific set of serving cells comprises a special cell and one or more secondary cells.

4. The method of claim 1, wherein:
the terminal does not cancel the SR in case that:
no valid PUCCH resource configured for the SR is available; and
the specific RRC message comprises the specific set of parameters.

5. The method of claim 1, wherein:
the terminal cancels the SR after transmission of the SR in case that valid PUCCH resource configured for the SR is available.

6. The method of claim 4, wherein:
random access is initiated for the SR in case that:
no valid PUCCH resource configured for the SR is available; and
the specific RRC message does not comprise the specific set of parameters,
random access is not initiated for the SR in case that:
no valid PUCCH resource configured for the SR is available; and
the specific RRC message comprises the specific set of parameters.

7. The method of claim 1, wherein:
the specific RRC message is a RRC message that comprises a set of parameters for synchronous reconfiguration; and
the specific RRC message is received by the terminal before the BSR is triggered.

8. The method of claim 7,
wherein the set of parameters for synchronous reconfiguration comprises:
a field for random access configuration;
a field for common configuration of a special cell;
a field for a first timer;
a field for a second timer; and
a field for the specific set of parameters.

9. The method of claim 8,
wherein the first timer starts in response to reception of the specific RRC message.

10. The method of claim 9,
wherein a target special cell is determined based on frequency of a source special cell after the first timer starts.

11. The method of claim 10,
wherein the second timer starts after the target special cell is determined.

12. The method of claim 11, wherein the terminal initiates:
connection reestablishment procedure in case that the first timer expires; and
acquisition of new assistance information in case that the second timer expires.

13. The method of claim 1,
wherein the specific logical channel is a logical channel configured for the specific RRC message.

14. The method of claim 1,
wherein the specific logical channel is a logical channel that belongs to logical channel group.

15. A terminal in a wireless communication system, the terminal comprising:
a transceiver configured to transmit and receive a signal, and
a controller configured to control the transceiver to:
triggering a buffer status report (BSR) in case that uplink data for a specific logical channel becomes available;
triggering a scheduling request (SR) in case that no uplink resource is available for new transmission; and
cancelling the SR without transmission of the SR in case that:
no valid PUCCH resource configured for the SR is available; and
a specific radio resource control (RRC) message does not comprise a specific set of parameters,
wherein the specific set of parameters comprises a parameter related to beam for physical downlink control channel (PDCCH) monitoring.
